(19) United States
(12) Patent Application Publication
(10) Pub. No.: US 2016/0199673 A1
(43) Pub. Date: Jul. 14, 2016

(54) CHILLED AIR RESPIRATOR AND RELATED METHOD FOR TREATING AIR

(71) Applicant: Bruce R. Berkson, Sedona, AZ (US)

(72) Inventor: Bruce R. Berkson, Sedona, AZ (US)

(21) Appl. No.: 14/991,061

(22) Filed: Jan. 8, 2016

Related U.S. Application Data
(60) Provisional application No. 62/101,245, filed on Jan. 8, 2015.

(51) Int. Cl. A62B 9/00; A62B 23/02; A62B 7/10

(52) U.S. Cl. CPC A62B 9/003; A62B 7/10; A62B 23/02

(57) ABSTRACT

A portable chilled air respirator device is used to treat air. Ambient air is drawn into an inlet of the device. The air is passed through a filter to filter the air. The air is cooled and dehydrated, such as by being passed over a reactant to create an endothermic reaction. The air is then secondarily cooled and rehydrated, such as by a secondary endothermic release of energy in an evaporative process, before being directed through the outlet of the device.

### RELATED APPLICATION

This application claims priority to U.S. Provisional Application Ser. No. 62/101,245, filed on Jan. 8, 2015.

### BACKGROUND OF THE INVENTION

The present invention generally relates to methods and devices for treating air. More particularly, the present invention relates to a portable chilled air respirator for filtering, cooling and hydrating air.

Pollution and poor air quality are an increasing problem throughout the world. People of every age and background suffer from negative effects of poor air quality. There is a continuing need to filter smoke, smog, pollen, dust, nuclear contaminants, biological contaminants and/or chemical contaminants under a variety of conditions, such as, public/private transportation, while working, walking, biking, hiking, or in any space with polluted air. The negative health impacts resulting from pollution is widely known. Although the effects of such pollution are particularly acute in certain workplace environments and when outdoors in a polluted environment, the ambient air in such polluted environment can also be found in vehicles, office buildings and residential buildings as well.

There are also incidents of a sudden emergency when there is a particular need to filter smoke, smog, pollen, dust, nuclear contaminants, biological contaminants and/or chemical contaminants in a short period of time in order to avoid adverse health consequences to those exposed to such contaminants and pollution.

There are also circumstances where people suffer from the negative effects of heat, which can result in general discomfort, heat stroke, heat prostration, heat syncope, dehydration and even organ failure. Thus, there is a continuing need to cool the air that contacts the body, particularly the torso, throat and head, to reduce core body temperature to safe levels. Such a need may result from weather conditions, work conditions, elevated temperatures within transportation vehicles, confined spaces, or in an emergency. The desirability to cool the air one breathes to reduce one's core body temperature to safe levels for prolonged periods of time may include while working, exercising, playing, during a prolonged emergency, sitting or sleeping in hot conditions and the like.

In some cases, the air one breathes needs to be properly hydrated in order to assist in maintaining adequate bodily hydration. In many instances, air that has been filtered and/or cooled lacks the necessary or desirable levels of hydration and thus can have a negative impact on the individual breathing such conditioned air.

Accordingly, there is a continuing need for treating air so as to filter, cool and appropriately hydrate the air for the benefit of the individual breathing the treated air. There is also a continuing need for a portable chilled air respirator that achieves these objectives that can be used by individuals in a variety of settings where such needs are found. The present invention fulfills these needs, and provides other related advantages.

### SUMMARY OF THE INVENTION

The present invention generally relates to a method for treating air using a portable chilled air respirator. The method of the present invention generally comprises the steps of providing a portable chilled air respirator device comprised of a housing having an air inlet and an air outlet.

Ambient air is drawn into the inlet of the device, such as using a fan disposed between the air inlet and the air outlet. The fan may be powered using a motor and batteries associated with the device. Alternatively, or additionally, a hand crank may be manually rotated to rotate the fan and/or recharge the batteries of the device.

The air is filtered, such as passing the air through a filter disposed between the inlet and outlet of the device. The filtering step includes filtering smoke, smog, pollen, dust, nuclear contaminants, biological contaminants and/or chemical contaminants from the air.

An endothermic reaction is created to cool and dehydrate the air. The endothermic reaction may be created by passing the air over a reactant. The reactant may comprise sodium bicarbonate and citric acid. Typically, the reactant is disposed within a removable cartridge of the device.

The air may then be rehydrated. This is accomplished by passing the air across water, such as a water-laden material or a mist of water. The evaporation of the water into the air serves to rehydrate the air. The evaporation process is also endothermic and secondarily further cools the air. A refillable water reservoir of the device may be used to provide the water, such as to the material which is operably associated with the refillable water reservoir.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an exploded perspective view of a portable chilled air respirator device embodying the present invention; and

FIG. 2 is a cross-sectional and diagrammatic view of a portable chilled air respirator device embodying the present invention.

### DETAILED DESCRIPTION OF THE PREFERRED EMBODIMENTS

As shown in the accompanying drawings, for purposes of illustration, the present invention resides in a personal and portable chilled air respirator device, generally referred to by the reference number 100, and a method of using the device 100 for treating and conditioning air. More particularly, the device 100 filters the air by a variety of potential filtration media, dehydrates and simultaneously chills the air by an endothermic chemical reaction, and/or cools and rehydrates the air by evaporative cooling processes before discharging the treated and conditioned air from the device 100.

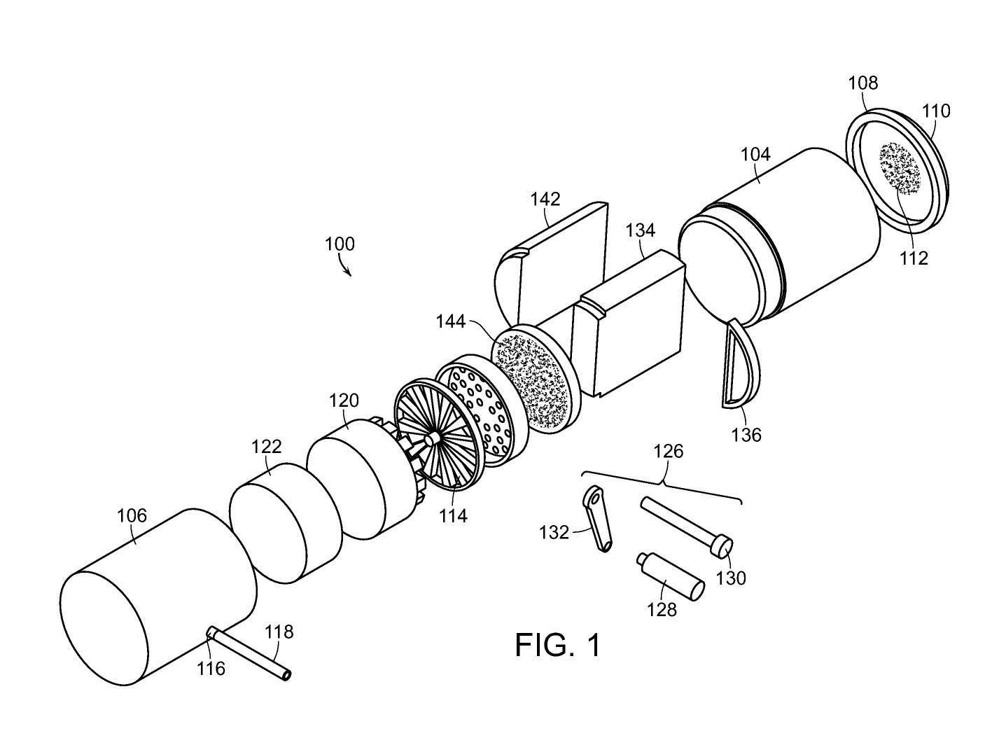

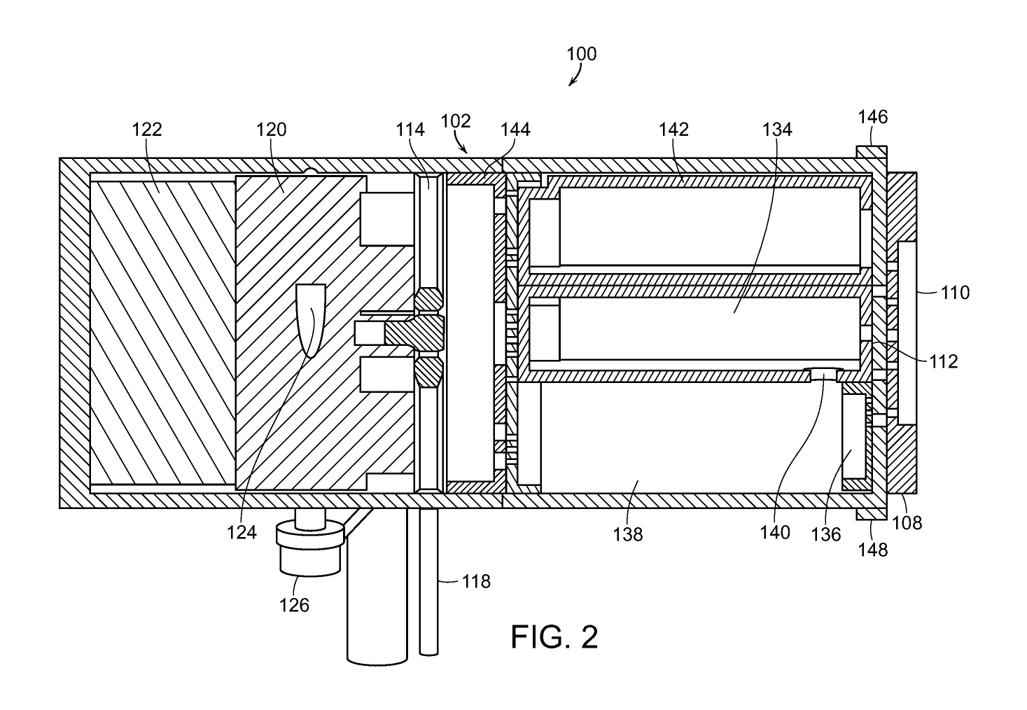

With reference to FIGS. 1 and 2, an exploded perspective view and cross-sectional and diagrammatic view of the chilled air respirator device 100 of the present invention is shown. The device 100 includes a housing 102 comprised of a first generally hollow housing body 104 attachable to a second generally hollow housing portion or body 106. The various components comprising the device 100 are typically disposed within the housing 102.

In the illustrated embodiment, a cap 108 is removably attachable to the first housing portion 104, and includes an air inlet 110. The cap 108 may be attached to the housing 102 by threaded connection, friction fit, or any other acceptable removable connection means.

As the air is drawn into the device 100, it passes through a filter 112. In the illustrated embodiment, the filter 112 is formed as part of the cap 108, or disposed between the cap 108 and the housing 102. It will be understood, however, that the filter 112 may be disposed within the housing 102. In any event, the filter 112 is disposed downstream of the air inlet 110, whether the air inlet is formed in a cap 108 or in the housing 102 itself.

The filter 112 may comprise an air filter, such as an HEPA filter, an activated charcoal filter, or any other filter type deemed appropriate. The filter 112 may comprise a nuclear contaminant filter, a biological contaminant filter or a chemical contaminant filter, or a combination thereof as needed in order to appropriately filter the ambient air. The filter media may be disposed within the housing 102, between the housing 102 and cap 108, as a removable cartridge component, or as a component formed integrally with the cap 108. In a particularly preferred embodiment, the filter 112 is removable so as to be replaced as needed with either a replacement filter or a new filter which is intended to serve a different filtration process, as needed.

A fan 114 is used to draw ambient air through the inlet 110, through the device 100, as will be more fully explained herein, and once conditioned, out outlet 116. Tubing 118 may be coupled to the outlet 116 to provide the treated and conditioned air to the appropriate connecting device or area of the individual to be treated. For example, the tubing 118 may be directly connected to a mouthpiece, a facemask, a helmet, or the like. The tubing 118 may also be connected to or directed to a hat, a neckerchief, mask, shirt, dress, vest, veil, coat and/or directly onto the head, neck, face, torso or the like of the individual so that the treated and conditioned air may either be inhaled and breathed and/or applied directly to the body surface of the individual as deemed desirable or necessary.

The fan 114 is operably connected to an electric motor 120, which is typically powered by one or more batteries 122. In the illustrated embodiment, the fan 114, motor 120, and one or more batteries or battery compartment 122 are housed within the second or lower portion 106 of the housing 102.

The one or more batteries 102 may be replaceable or rechargeable. A port 124 may be formed through the housing 102 to enable electrical connection between an AC/DC current converter to power the motor 120 directly and/or recharge the one or more batteries 122. Alternatively, or in addition to, a hand crank 126 can be used to manually rotate the fan 114 and/or recharge the one or more batteries 122, such as the hand crank 126 being operably coupled to a dynamo and commutator or electric generator. The hand crank 126 can comprise a handle 128 connected to a rotatable shaft 130, such as by rotatable interconnecting member 132. Rotation of the shaft 130 causes the flywheel 114 to rotate and/or the electric generator to be actuated and recharge the one or more batteries 122. The hand crank 126 may be connected to the electric generator and/or fan 114 through a manual crank port or the like so as to be removable and only used when deemed unnecessary or desirable, such as when the batteries are depleted and/or when no source of electricity for the charger is available.

The hand crank 126 may be used and attached to a flywheel-weighted dynamo with commutator, alternator, or other electric generator with an AC/DC converter, as needed, to recharge the battery or sustain operation of the device 100 as needed, such as during prolonged or emergency use. During normal use, however, the electricity will be supplied directly by means of an adapter plugged into a wall outlet, or more typically, by means of the one or more batteries as the device 100 is portable and intended to be carried by an individual as he or she is walking, hiking, commuting, working, etc. The device may be activated manually, by pressure switch, by timed switch, by CPAP switch, by computer-controlled switch, or any other viable means of control. The device may run continuously so as to continuously draw air through the inlet 110, treat and condition the air, and emit it through outlet 116, or only periodically as deemed desirable or necessary.

In accordance with the present invention, the air, typically after being filtered by filter 112, is cooled. The air may also be dehydrated. This may be accomplished simultaneously by creating an endothermic reaction to cool and dehydrate the air. This is typically done by passing the air over a reactant which when is in contact with the air creates an endothermic reaction. For example, in one embodiment, the reactant comprises a mixture of sodium bicarbonate and citric acid.

In the illustrated embodiment, a removable reactant cartridge 134 holds the reactant substance which is applied, as necessary, to an absorptive media element 136, through which the air passes. Both the reactant cartridge 134 and the reactant media element 136 may be removable and replaced and/or recharged as necessary. The media cartridge 136 serves the purpose of providing chilling media within the device 100, such that as the air passes over or through the cartridge 136 an endothermic chemical reaction occurs which serves to cool the air. The reactant material 134 may be selected in order to also dehydrate the air, such as using the combination of sodium bicarbonate and citric acid reactant described above. With reference to FIG. 2, this may occur in a chilling chamber 138 as the air passes through or over the reactant media cartridge or member 136. A port 140 provides a pathway for the reactant material from the reactant cartridge 134 to be disposed upon and drawn to the reactant cartridge or media 136. As mentioned above, the reactant cartridge 134, and reactant media element or cartridge 136, may be removed and replaced or recharged as needed as the reactant substance is exhausted due to the endothermic chemical reaction with the air.

In order to condition the air, the air may need to be hydrated if the ambient air is of a very low humidity, or rehydrated due to the dehydration of the air when encountering the reactant material or substance. As such, a refillable or replaceable water cartridge 142 is provided, typically disposed within the housing 102. The air is passed across water. This is typically done by providing a media or material 144 which is capable of absorbing water and through which the air can pass through or around. The material is operably associated with the refillable water reservoir 142 so as to draw water thereto as the water is evaporated by the passing air as it is rehydrated. A port is provided for refilling the water cartridge 142. A water primer bulb cap 146 may be positioned over the refill port for pressurizing the water container 142 so that it provides water to the material or media cartridge 144 and/or creates a water mist through which the air passes. Pressurizing the water reservoir 142 also enables the device 100 to be used regardless of the angle which the device 100 is disposed, so as not to require gravity feed of the water to the media element 144.

Similarly, a manual primer bulb cap 148 may be associated with the reactant cartridge 134 so as to pressurize the contents of the reactant cartridge 134 to ensure that the reactant substance is properly conveyed to reactant cartridge media 136 at all times, irrespective of the angle or position of the device 100. The manual priming bulbs may be comprised of an elastomeric material which can be repeatedly depressed in order to pressurize the water container 142 and/or reactant cartridge 134. Instead of serving to pressurize these cartridges 134 and 142, the manual depression of the primer bulbs 146 and/or 148 could be used instead to administer a portion of water or reactant to the appropriate media element material 136 or 144.

After the ambient air has been drawn by fan 114 through the inlet 110 of the device 100, past filter 112, reactant material or media 136 and chilled and/or dehydrated, and rehydrated after passing through or over water-laden material 144 to a desired level of humidity, it is passed through outlet 116 to the intended mouthpiece, mask, item of clothing and/or body surface area as needed or desired. The treated air will have been filtered, cooled and hydrated, as needed. As such, the individual user will be able to receive and breathe the treated and conditioned air free from pollutants and/or apply the treated air directly onto a body surface for cooling the individual when necessary.

As mentioned above, it is anticipated that over time the reactant and/or the water will become exhausted. As such, the invention provides a means for either refilling or recharging the cartridges 134 and 142 while within the device 100, or opening the housing 102 and removing and replacing or refilling or recharging the cartridges 134 and 142 as necessary. The cartridges 134 and 142 may be placed 45° to 90° apart, and/or have insertion guides so that they, and their respective media element cartridges 136 and 144 can be only fully inserted in a proper way.

While the filtered air is passed over the reactant (which in a preferred embodiment is a sodium bicarbonate infused with a non-toxic chemical reactant, such as citric acid) the air is both cooled due to the endothermic reaction and dehydrated. When the air is passed over the water-laden material of cartridge 144, the evaporative process of passing over the water acts as another endothermic process and further cools the air. Such cooling of the air can be advantageously used to lower an individual's core body temperature such as when in extreme heat situations due to weather, activity, an emergency situation or the like.

In the event that the device 100 does not activate the endothermic chemical reaction, either selectively controlled by the device 100 or by means of the reactant material being exhausted, the filtered air is cooled only by the evaporative cooling media element 144 alone, which will cool and hydrate the air due to the evaporative processes involved as the air passes over the wet material cartridge 144.

However, in other instances, the evaporative media cooling cartridge 144 may not be utilized, either selectively controlled by the device 100 such as when the ambient air is at a relatively high humidity level or when the water is depleted from the water cartridge 142, or the evaporative cooling component is not desired. In that case, the filtered air is cooled only by the endothermic chemical reaction alone.

It is also contemplated by the present invention that the air will only be filtered by means of passing through filter 112. This may be the case when cooling and/or hydration of the air is not necessary or deemed desirable. This may also be the case if the reactant material and water have been exhausted. This may also be the case, for example, if the water or reactant material is not automatically supplied to the respective absorptive media element cartridge 136 or 144, and instead water and/or reactant material is only conveyed to these media members 136 and 144 when manually actuated, such as depressing the primer bulbs 146 and/or 148.

The invention contemplates the use of sensors that analyze the ambient relative humidity and temperature, or by computer control adjust the rate of reactant liquid and/or air flow to the absorptive media elements to optimize the chilling effect and hydration of the air. The device 100 of the present invention may also interact with an external device, such as a smart phone or other handheld device by means of an embedded smart device application, by infrared signal, RFID, Bluetooth signal or any other form of interconnectivity with a smart device, which allows for optimum system control, monitors input such as ambient temperature, relative humidity and body function status while optimizing efficiency if use and minimizing amperage draw. Such smart device may allow for signal location by GPS mapping, respiration/heart rate monitoring and/or any other smart phone application capability. Such a smart device may comprise a wearable extension, such as a bracelet or watch or the like, which provides these features.

It will be appreciated that the device 100 of the present invention may be carried and/or transported by a user in numerous ways, including but not limited to, a specially-designed backpack, waste pack, thigh strap, torso strap, neck strap, lanyard, sling, or integrated with specially-designed clothing, hats, helmets, masks, or attached to and carried by other devices such as a bicycle, scooter, motorcycle, automobile, or any other means of conveyance or transportation. As mentioned above, the device 100 may be in continuous use or selective use, such as by manually activating the device 100, operating the device 100 by means of a timer, or when sensed conditions indicate the need and desire to treat the ambient air or the user thereof.

Although several embodiments have been described in detail for purposes of illustration, various modifications may be made without departing from the scope and spirit of the invention. Accordingly, the invention is not to be limited, except as by the appended claims.

What is claimed is:

1. A method for treating air using a portable chilled air respirator, comprising the steps of:
providing a portable chilled air respirator device comprised of a housing having an air inlet and an air outlet;
drawing ambient air into the inlet of the device;
filtering the air;
creating an endothermic reaction to cool and dehydrate the air;
rehydrating the air; and
directing the filtered, cooled and rehydrated air through the outlet of the device.

2. The method of claim 1, wherein the filtering step comprises the step of passing the air through a filter disposed between the inlet and outlet of the device.

3. The method of claim 2, wherein the filtering step includes the step of filtering smoke, smog, pollen, dust, nuclear contaminants, biological contaminants and/or chemical contaminants from the air.

4. The method of claim 1, wherein the providing step includes the step of providing a fan disposed between the air inlet and outlet.

5. The method of claim 4, including the step of powering the fan using a motor and batteries associated with the device.

6. The method of claim 4, including the step of manually rotating a hand crank to rotate the fan and/or recharge batteries of the device.

7. The method of claim 1, wherein the creating an endothermic reaction step comprises the step of passing the air over a reactant.

8. The method of claim 7, wherein the reactant comprises sodium bicarbonate and citric acid.

9. The method of claim 7, wherein the reactant is disposed within a removable cartridge of the device.

10. The method of claim 1, wherein the rehydrating step comprises the step of passing the air across water.

11. The method of claim 10, wherein the air is passed over a water-laden material.

12. The method of claim 10, wherein the material is operably associated with a refillable water reservoir of the device.

13. The method of claim 10, wherein the rehydrating step further cools the air.

14. A method for treating air using a portable chilled air respirator, comprising the steps of:
providing a portable chilled air respirator device comprised of a housing having an air inlet and an air outlet;
drawing ambient air into the inlet of the device using a fan disposed between the air inlet and the air outlet;
filtering the air by passing the air through a filter disposed between the air inlet and the air outlet;
creating an endothermic reaction to cool and dehydrate the air by passing the air over a reactant disposed between the air inlet and the air outlet;
rehydrating the air by passing the air over a water-laden material or through a mist of water; and
directing the filtered, cooled and rehydrated air through the outlet of the device.

15. The method of claim 14, wherein the filtering step includes the step of filtering smoke, smog, pollen, dust, nuclear contaminants, biological contaminants and/or chemical contaminants from the air.

16. The method of claim 14, including the step of powering the fan using a motor and batteries associated with the device.

17. The method of claim 14, including the step of manually rotating a hand crank to rotate the fan and/or recharge batteries of the device.

18. The method of claim 14, wherein the reactant comprises sodium bicarbonate and citric acid.

19. The method of claim 14, wherein the reactant is disposed within a removable cartridge of the device.

20. The method of claim 14, wherein the water-laden material is operably associated with a refillable water reservoir of the device.
